(19) United States
(12) Patent Application Publication
(10) Pub. No.: US 2010/0312847 A1
(43) Pub. Date: Dec. 9, 2010

(54) METHOD FOR AUTHORIZING A WATCHER BY PROVIDING WATCHER SPECIFIC INFORMATION TO THE PRESENTITY

(76) Inventors: Christer Boberg, Tungelsta (SE); Mikael Klein, Huddinge (SE); Sofie Lassborn, Sollentuna (SE); Anders Lindgren, Alvsjo (SE)

Correspondence Address: ERICSSON INC., 6300 LEGACY DRIVE, M/S EVR 1-C-11, PLANO, TX, 75024, US

(21) Appl. No.: 12/867,105

(22) PCT Filed: Feb. 12, 2008
(86) PCT No.: PCT/SE08/50162

§ 371 Date: Aug. 11, 2010

(51) Int. Cl. G06F 15/16

(52) U.S. Cl. 709/206

(57) ABSTRACT

A method of authorizing a request for presence information of a first client, which is received from a second client. The authorization procedure comprises providing at least one attribute, associated with the preferences of the second client to the first client as an XML extension document. After having interpreted the one or more attributes, the second client may choose to authorize the request, either according to the request, or according to a sub-set thereof, or to deny the request.

### TECHNICAL FIELD

The present invention relates generally to a method for authorizing a Watcher, and more specifically for providing Watcher specific information to a Presentity, wherein the Watcher specific information is to be used in the authorization process.

### BACKGROUND

The IP Multimedia Subsystem (IMS) is an architecture based on the Session Initiation Protocol (SIP) which creates a common platform for enabling a broad range of advanced Internet-based multimedia services and applications on top of a packet switched network.

IMS presence is one example of a SIP event package or a SIP service that a user can subscribe for in order to obtain information about another users reachability, availability and/or willingness of communication. A user, typically referred to as a Watcher, may initiate a subscription, requesting for presence information, i.e. a set of attributes that characterise some properties of another user, typically referred to as a Presentity.

A Watcher may retrieve current presence information associated with a Presentity instantly, or may subscribe to presence information of a Presentity, wherein the Watcher is continuously notified of future changes in the presentity's presence information until an authorized subscription expires, or until the Watcher terminates the service.

A simplified example of a general SIP-based presence architecture in the IMS, according to the prior art, is illustrated in FIG. 1. The SIP/IMS network is a network of servers, that perform a variety of services in support of the presence service, such as e.g. routing, authentication and compression. When the presence service is realized using IMS, the SIP/IMS network will perform a number of additional functions in support of the presence service, such as, e.g. routing of the SIP signaling between presence sources, Watchers and a presence system, performing of authentication and authorization of the described entities, maintaining of the registration state and providing of charging information.

FIG. 1 shows a Watcher 100, comprising a Watching client, requiring presence information associated with another user. Watcher 100 may get access to requested presence information provided via SIP/IMS network 101 via access network 102. The user of interest to the Watcher 100, is typically referred to as a Presentity 103. Presentity 103 may access the SIP/IMS network 101 via the same access network as the Watcher 100, or as in this case, via another access network 104.

Throughout this document, both the Watcher 100 and the Presentity 103 will be defined as a combination of a user, or an automated function operating on behalf of a user, and a user agent (UA) located in an IMS terminal, such as e.g. a stationary PC, a laptop, a PDA or a cellular telephone, and adapted to provide a number of services, each of which is identified by a SIP event package, to the user.

The IMS network consists of conventional IMS nodes, such as Proxy Call Session Control Functions 105, 106 (P-CSCF's), being the first point of contact between an IMS terminal and the SIP/IMS network, Serving Call Session Control Functions 107 (S-CSCF's), being the central node of the signalling plane and Interrogating Call Session Control Functions 108 (I-CSCF's), providing SIP proxy server functionality, as well as conventional databases, i.e. one or more Home Subscriber Servers 109 (HSS), being the central repository for user-related information, and, in case the network comprises more than one HSS, a Subscriber Location Function 110 (SLF), responsible for mapping user's addresses to an appropriate HSS.

In addition to the nodes mentioned above, the SIP/IMS network also typically comprises a plurality of Application Servers (AS's), which are SIP entities that hosts and executes different types of services to authorized users. FIG. 1 comprises two AS's, namely a Presence Server 111 (Presence Server), which may be responsible for managing a presence service, and a Presence Source 112, which is an entity responsible for providing updated presence information to authorised Watchers via the Presence Server 111 on behalf of a Presentity.

A Presence Source, which may be located in a users UE or within a network entity, may be, e.g. a Presence Network Agent (PNA), providing presence information, i.e. publications associated with one or more Presentities from a Location Server, a Calendar Server, an MSC or any other source (not shown).

The network also comprises a Resource List Server 113 (RLS). An RLS is a functional entity that accepts and manages subscriptions to presence lists, which enables a Watcher to subscribe to presence information of multiple entities using only one single subscription transaction, thereby saving not only bandwidth, but also reducing the power consumption of the Watchers UE's.

The RLS will be able to subscribe to changes according to presence lists managed by, and stored in, a Resource List Server XML Document Management Server (RLS XDMS) (not shown). An XDMS is an XCAP server and SIP Notifier that supports management of XML documents, such as e.g. presence lists, which are specific to the use of RLS.

Although FIG. 1 only comprises one Presence Source, there are typically a plurality of different Presence Sources available at a SIP/IMS network, each of which is providing presence information of different categories to one or more Presence Server's. It is also to be understood that a typical SIP/IMS network may comprise additional CSCF nodes of the types already mentioned, as well as other types of nodes which, however, have been omitted in this presentation since they are of no relevant importance to the understanding of the authorization mechanism being the scope of this document.

As indicated above, the management of a presence service requires functionality which is adapted therefore.

FIG. 2 illustrates a simplified OMA Presence architecture, comprising such functionality, according to the prior art. For simplicity reasons the SIP/IMS infrastructure has been omitted in this figure. Although a typical scenario will comprise a plurality of Watchers, as well as a plurality of Presentities, only one Watcher and one Presentity are shown in the figure, for simplicity reasons.

A Watcher 200 may request for presence information of a Presentity 201, by forwarding a SIP subscribe request to a Presence Server (Presence Server) 202 of a Presence System 203, defined by the entities located within the dotted square. In response to the SIP subscribe, the Presence Server 202 interrogates a Presence XML Document Server (Presence XDMS) 204, to determine whether Watcher 200 has already been authorized by Presentity 201. The Presence XDMS 204 is an XCAP server and a SIP Notifier that supports management of XML documents, such as, e.g. presence authorization policies which are specific to the presence service enabler, in this case Watcher 200. In addition, the presence XDMS 204 notifies Watchers of changes to the presence-specific documents stored in the network.

If already authorized the Watcher 200 receives an acceptance from Presence Server 202. If not authorized, the Presence Server 202 will request for an authorization by generating and transmitting a SIP notify message to Presentity 201, allowing the Presentity 201 to determine whether the request should be authorized or not, and, if authorized by the Presentity 201, Presence Server 202 will be able to distribute relevant Presence Information to Watcher 200, all according to relevant Presence Rules stored in the Presence XDMS 204.

Presence Information may be provided to Presence Server 202 from different AS's or Presence Sources. In FIG. 2, three different presence sources 205,206 and 207, in this case referred to as PNA's, are providing Presence Server 202 with updated Presence Information, delivered in SIP publish messages. Each PNA is connected to a server, providing specific information associated with different Presentities, such as e.g. Presentity 201. PNA 205 handles location information from a Location Server 208, PNA 206 is connected to an MSC 209, which may provide information such as, e.g. routing information to Presence Server 202, while PNA 207 is handling relevant presence information from a Calendar Server 210.

Presence Server 202 accepts presence information which has been published to it, and distributes it to authorized Presentities via SIP notify messages.

As described above, subscriptions are typically managed by an RLS 211, which is able to subscribe to changes to documents stored in an RLS XDMS 212, both entities being entities of the Presence System 203.

Apparently, the Presence System entities can be seen as representatives of a Presence System, which manages and provides presence information associated with one or more Presentities to Watchers which have been authorized by a respective Presentity.

As part of the power-on procedure, a Presentity will send a SIP subscribe request to the responsible Presence Server, requesting to be updated with the Watcher information (Winfo) event package of each Watcher that is interested in retrieving presence information of the Presentity. The Presentity will then be notified whenever there is a new Watcher requesting for presence information associated with the Presentity. For each new Watcher that requests for presence information of the Presentity, the Presentity will be able to decide whether to authorize the Watcher or not. Before the Watcher's request has been authorized, no presence information will be distributed from the Presentity.

According to relevant prior art, a Watcher may also include a filter in the initial subscription request, specifying a sub-set of Watcher specific information, which may be defined e.g. as presence attributes that are of special interest to the Watcher. Only those attributes requested by the Watcher will be delivered to the Watcher, thereby avoiding transmission of irrelevant information, and, thus, reducing the network load. The Presentity will, however, not be able to access the filter information.

One problem with the standard approach described above is that a Presentity, receiving a notification from a Watcher in association with a request for presence information will be completely unaware of what categories of presence information, e.g. what presence attributes, that he or she is actually about to authorize.

Presently there is a mechanism which allows a Presentity to authorize all attributes, or just a sub-set of a requested set of presence attributes. Such a mechanism does, however, not have any relation to the preferences of the Watcher, since there is no way to convey that information in the Watcher Info, delivered to the Presentity in the notification.

### SUMMARY

It is an object of the present invention to address at least some of the problems outlined above. Further, it is an object of the present invention to provide a mechanism for enabling a Presentity to authorize a Watcher on the basis of watcher specific information that is provided to the Presentity in an authorization procedure. These objects and others may be obtained by a method and clients according to the attached independent claims.

According to one aspect, a method is provided for responding to a request for presence information associated with a first client, the request being initiated by a second client, wherein the method comprises a number of steps, executed by the first client. Initially, the first client receives a request message, requesting for presence information of the first client, from a presence system. The request comprises a set of client specific information associated with the second client, and the client specific information comprises one or more attributes. The one or more attributes are then being interpreted and presented to the user of said first client. Upon receiving a response to the presentation, a response message, authorizing the request according to the one or more attributes, or a sub-set thereof, or denying the request, is generated and transmitted to the presence system. The interpreting step may comprise a step of obtaining an interpretation of one or more attributes from a pre-configured table, e.g. by transmitting a HTTP request to a WEB server.

According to another aspect, a method is provided for requesting for presence information associated with a first client. The method comprising a number of steps starts with the generating of a request message, wherein the request message requesting for presence information, comprises client specific information associated with the second client. Subsequent to having transmitted the request message to a presence system, a response message, responding to said request message, will be received. The response message may be authorizing the request, according to the one or more attributes, or a sub-set thereof, or denying the request, wherein the one or more attributes are associated with the specific information, and provided to the first client from the presence system.

According to one embodiment, the client specific information may be an XML document extension, comprising one or more attributes, wherein the XLM document extension may be a filter.

According to another embodiment, the client specific information may instead be transmitted to the presence server in the SIP header of the request message.

According to yet another aspect, a method is provided for handling a request for presence information associated with a first client, wherein the request is initiated by a second client. The method comprises a number of steps to be executed by a presence system, starting with receiving a first request message from the second client, wherein the first request message is a request for presence information of the first client, comprising a first set of client specific information associated with the second client. A second request message, comprising a second set of client specific information associated with said first set of client specific information, is then generated, wherein the second set of client specific information comprises one or more attributes. Upon having transmitted the second request message to the first client, a first response message will be received from the first client message, wherein said first response message, being a response to the second request message, either authorizes the request according to all, or a sub-set of the one or more attributes, or denies the request. Next a second response message is generated on the basis of the content of the first response message, in response to receiving the first response message, and transmitted to the second client.

According to one embodiment, the second set of client specific information may be an XML document extension, comprising one or more attributes, associated with the second client.

Prior to generating a request message, content of the first set of client specific information may be mapped to one or more attributes stored in a pre-configured filter.

The claimed invention also comprises clients which are adapted to perform the method according to the different aspects described above.

A method and clients operating according to the principles described above may assure that a first client is provided with an adequate amount of facts about a second client to be able to make a more substantiated authorization decision.

The method and the clients may also enable a second client, requesting for presence information of a first client, to support the first client in its authorizing decision, by providing substantial information, indicating preferences of the second client in a more or less detailed manner. The features and benefits of the present invention will become apparent from the detailed description below.

### BRIEF DESCRIPTION OF THE DRAWINGS

The present invention will now be described in more detail by means of exemplary embodiments and with reference to the accompanying drawings, in which:

FIG. 1 is an example of a general IMS-based presence architecture, according to the prior art.

FIG. 2 illustrates a simplified Presence architecture, according to the prior art.

FIG. 3 is a signalling scheme, illustrating an authorization procedure to be executed in association with receiving a request for Presence Information, according to one embodiment.

FIG. 4 is a block diagram, illustrating the steps of a method of authorizing a presence service to be executed by a Watching Client, according to one embodiment.

FIG. 5 is a block diagram, illustrating the steps of the suggested authorizing method to be executed by a Presentity Client.

FIG. 6 is a block diagram, illustrating the steps of the suggested authorizing method to be executed by the Presence System.

FIG. 7 is a system architecture, illustrating one example of generic functionality of a Watcher Client adapted to execute the suggested authorization method.

FIG. 8 is a system architecture, illustrating one example of generic functionality of a Presentity Client adapted to execute the suggested authorization method.

FIG. 9 is a system architecture, illustrating one example of generic functionality of a Presence Server of a Presence System adapted to manage the suggested authorization method.

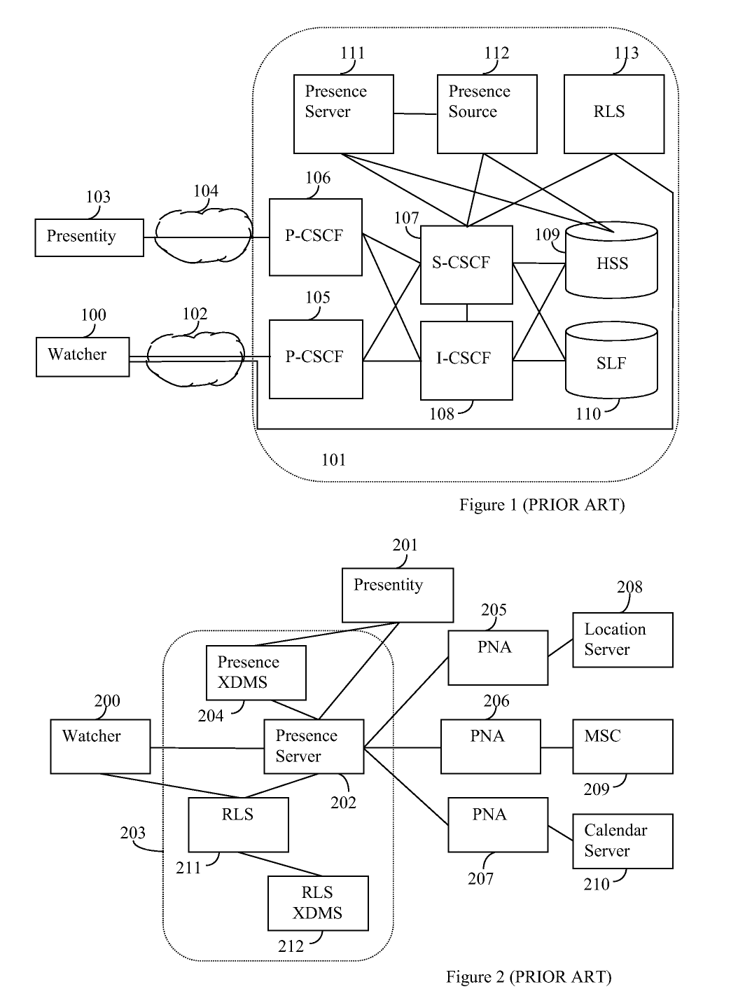

### DETAILED DESCRIPTION

Briefly described, the present invention provides a solution where a Presentity will have access to information associated with a Watcher, when making a decision whether to authorize or deny a request for presence information received from the Watcher.

Based on the content of the Watcher information, typically one or more Watcher specific attributes, the Presentity will be able to authorize a subscription according to all attributes, or to just a sub-set of the attributes provided with the request.

In addition to attributes, selected by the Watcher, a Presentity may also choose to authorize additional attributes which have not been selected by the Watcher.

The authorization mechanism mentioned above may be achieved by transmitting Watcher specific information to a Presence Server in a request for presence information, e.g. in a SIP subscribe, and by delivering associated Watcher specific information not only to the Presence Server, but also to the Presentity. By delivering Watcher specific information in some XML document extension, comprising one or more attributes chosen by a Watcher, all the way to the Presentity, instead of transmitting this kind of information just to the Presence Server, the Presentity will be aware of exactly what type of Presence Information the Watcher is interested in, and, thus, only those attributes, or a sub-set of attributes, identifying information that the Presentity is willing to reveal to the Watcher will have to be authorized by the Presentity.

By implementing the proposed authorization mechanism, the Presentity will be able to avoid declining a subscription request for presence information simply because he/she does not know what presence information that is actually being authorized.

The Presentity will also have access to a pre-configured table, comprising interpretations of the attributes that may appear in the XML document extension. By introducing such a table, the XML document extension, which may be e.g. a filter delivered to the Presentity, may be used for delivery of a wide range of more or less detailed watcher specific attributes, each of which is presented in a globally unique format, and each of which may provide detailed information of the watcher preferences to the Presentity.

According to one embodiment, a first set of watcher specific information that has been transmitted from a Watcher to a Presence Server together with Winfo will also be inserted into a notification, i.e. in a SIP notify message, and transmitted from the Presence Server to the Presentity in the notification.

According to another embodiment, no XML document extension adapted for transmission of the watcher specific information to the Presence Server is available. Instead a first set of watcher specific information, comprising information such as such as e.g. UE type, may be transmitted in the User Agent header of a subscription request, all according to prior art procedures of information delivery via the User Agent header. The Presence Server receiving such a request may be adapted to map the retrieved first set of watcher specific information against a pre-configured filter, stored at, or in connection to, the Presence Server of the Presence System.

Filter content that match the Watcher specific information, i.e. one or more attributes associated with the Watcher, will then be forming a second set of watcher specific information, which is delivered to the Presentity in the notification, and presented to the Presentity. The second set of watcher specific information may be any type of XML document extension, typically a filter. The Presentity will then be able to use the second set of watcher specific information when making an authorization decision of the subscription request, in the same way as for the first embodiment.

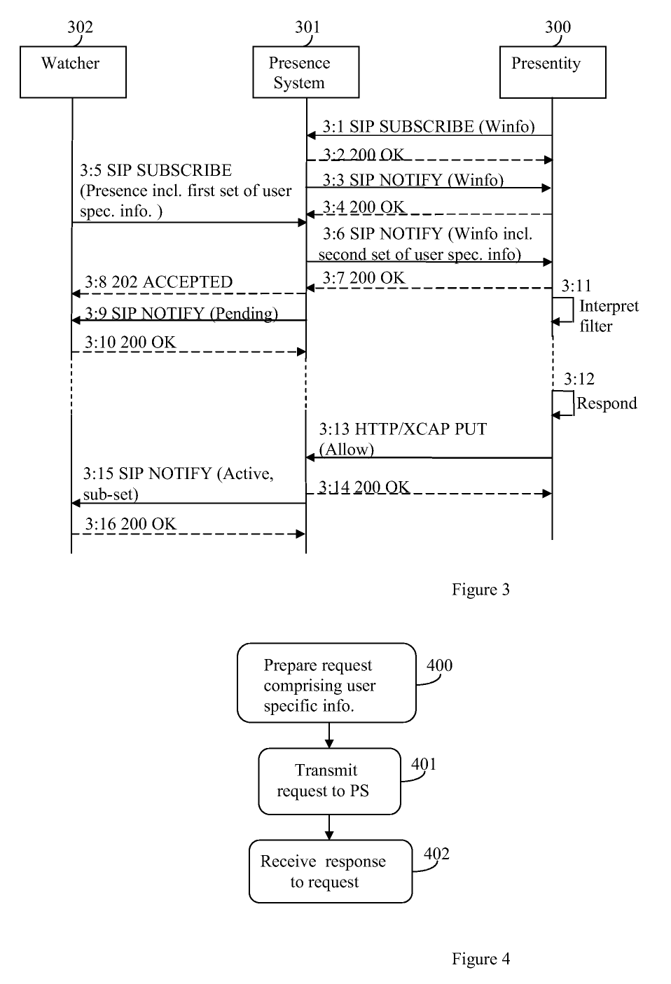

A method for providing watcher specific information to a Presentity according to any of the embodiments described above will now be described in more detail with reference to the signalling diagram of FIG. 3.

As mentioned above, a Presentity needs to be informed of which Watchers that are interested in receiving presence information of the Presentity. As part of the conventional power-on procedure, a Presentity 300 therefore sends a SIP subscribe message to a Presence Server of a Presence system 301, requesting for Winfo event packages of Watchers, requiring presence information associated with Presentity 300. In this context, Presence System 301 is represented by a modified Presence Server and a conventional Presence XDMS. Such a request is sent in a first step 3:1.

Presence Server of Presence System 301 normally responds to this request by transmitting a 200 OK to the Presentity in a next step 3:2, and since no pending subscription exists, waiting to be authorized, an empty Winfo notification will then be transmitted from Presence Server 301 to Presentity 300 in another step 3:3. This is responded to by the Presentity in a subsequent step 3:4.

From now on the Presentity 300 will be notified whenever Presence System 301 is made aware of a new Watcher that shows interest in Presence Information of the Presentity 300 if the Presence XDMS comprises specific predetermined rules, defining such conditions.

At a next step 3:5, a Watcher 302, requiring presence information of Presentity 300 sends a subscription request, i.e. a SIP subscribe, for subscribing for presence information, to Presence System 301. In order to make it easier for the Presentity to make an adequate decision as to whether the request should be authorized or not, the Watcher 302 will include a first set of watcher specific information into the SIP subscribe.

In addition to more general information, indicating whether or not the Watcher is interested in certain categories of information, such as e.g. the instant messaging capabilities, communication addresses, location information or calendar information of a Presentity, the first set of watcher specific information may also comprise more detailed preferences associated with the Watcher, such as e.g. preferences for location information, but with a restriction, which may be specified as a request for location information only when the respective Presentity is visiting one or more certain specified areas, and/or only within certain time intervals.

As indicated above, the first set of watcher specific information may be delivered as an XML document extension, e.g. a filter, or as user agent information that is associated with the Watcher. User agent information may comprise information such as e.g. the present type of UE, present UE mode, or present UE location.

The Presence Server of Presence System 301 then generates a Winfo notification, i.e. a SIP NOTIFY message, comprising the Winfo associated with Watcher 302. In addition to this information, the notification will also comprise a second set of watcher specific information that is inserted into the notification.

According to the first embodiment mentioned above, the first set of watcher specific information, i.e. a first set of attributes selected by the Watcher 302, may be inserted also into a notification to be delivered to Presentity 300 as a second set of attributes, in response to the subscription request received in step 3:5.

According to the second embodiment, the Presence System 301 may have access to a pre-configured filter, each filter being stored as an XML document at, or in connection to the Presence System. If this is the case, the first set of watcher specific information delivered in the subscription request may be mapped against the pre-configured filter once received at the Presence System 301. As a result of the mapping, one or more attributes which are corresponding to the first set of watcher specific information will be identified, forming a second set of watcher specific information, i.e. an XML document extension, such as e.g. a filter, for distribution to the Presentity.

Such a notification, transmitted according to any of the two embodiments described above, is then transmitted to Presentity 300 in a notification in the subsequent step 3:6, and Presentity 300 verifies a reception of the notification to Presence System 301 in a subsequent step 3:7, which is followed by another verification, transmitted to Watcher 302 in a subsequent step 3:8.

The Presence System 301 also indicates to Watcher 302 that the request will be pending until it has been authorized or denied by Presentity 300. This is done in another step 3:9, and responded to in a subsequent step 3:10.

In addition to inserting the Winfo of Watcher 301 into the SIP NOTIFY message transmitted in step 3:6, an XML document extension, associated with Watcher 302 and retrieved according to any of the embodiments described above, will be delivered in the notification.

The Presentity 300, receiving the notification, retrieves the XML document extension and interrogates a database (not shown) in order to obtain an interpretation of the content of the XML document extension, i.e. the one or more attributes provided from the Watcher 302 or the Presence System 301. Such a procedure is indicated as a step 3:11 in FIG. 3. An interpretation of attributes may e.g. be executed by interrogating a separate server, such as e.g. a WEB server, transmitting a HTTP request to the server.

The interpreted attributes may now be visually presented to the Presentity 300, via a conventional User interface of a Presentity client (not shown). Based on the presented attributes, the Presentity may choose to authorize the requested attributes as requested or a sub-set of the requested attributes, or to deny the requested subscription, and, thus, deny Watcher 302 access to any kind of presence information. If authorizing a request according to at least one attribute the Presentity 300 may also choose to authorize additional attributes, which may not even have been selected by the Watcher 301. Such a decision which may be taken instantly in response to step 3:11 or at a later occasion is indicated with a step 3:12.

Once Presentity 300 has made a decision, a response will be generated in the form of an XML document, which is transmitted to the Presence XDMS of Presence System 301, typically in an HTTP/XCAP put, as indicated in another step 3:13, and a response is transmitted to Presentity 300 in a subsequent step 3:14.

The request may be replied to with any of the alternative rule types “Block”, “Polite Block”, or “Allow”. Rule type “Block” indicates that the Watchers request will be denied. “Polite Block” is an alternative way of denying the Watcher the requested Presence Information. The Watcher having received a Polite Block will, however, experience the reply as an acceptance, receiving a reply comprising some incorrect Presence Information, but which appears to the recipient as being correct. “Allow” will indicate an acceptance of the request to the Watcher.

Subsequent to step 3:13, Presence XDMS interacts with Presence Server, and once again Presence Server evaluates the authorization rules, set for Watcher 302, in order to verify if there are any pre-defined restrictions as to the authorised attributes, all according to known procedures.

A positive evaluation is an indication that Watcher 302 is authorized by the Presentity 300, and, thus, this will be reported to Watcher 302 in a subsequent notification, which will comprise content dependent of the first response, sent in step 3:13. This notification will typically comprise the authorized set, or sub-set of attributes indicated in the first response, as indicated in another step 3:15.

If any restrictions were identified in the evaluation of the authorization rules, a restricted authorization will result in a limited sub-set being delivered to Watcher 302 in the notification of step 3:15.

If authorized, this is indicated as “Active”, while a denial of the requested subscription will be indicated as “Terminated” in the notification, sent to Watcher 302 in step 3:15. Once the Watcher 302 has received a verification of a successful authorization, or a denial of the request, the authorization procedure is completed.

The authorization method described above will require that a Watcher Client of a user equipment of a Watcher has been adapted accordingly.

FIG. 4 illustrates the described method according to one embodiment, the method executed by a Watcher client being illustrated as a block diagram.

In a first step 400, a request for presence information is processed, wherein the request, e.g. a SIP subscribe message, is provided with user or Watcher specific information. Such Watcher specific information, may either be defined by one or more attributes, provided to the User Equipment of the Watcher e.g. via a conventional User Interface, in case the watcher specific information is provided from the Watcher as an XML document extension, or as information provided via the User Agent header of the request, if a pre-configured filter is instead available at the Presence Server. In a next step 401, the request is transmitted to the relevant Presence Server, and in a final step 402, the Watcher awaits and receives a response to the request.

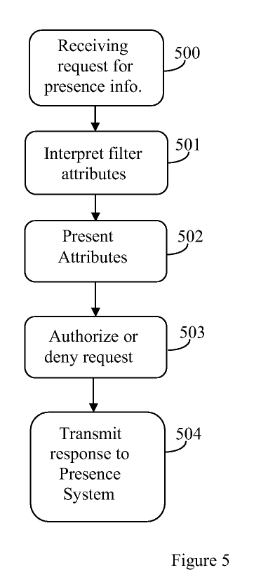

Also a Presentity client, of a user equipment of a Presentity that is to execute the suggested authorization method described above will have to be adapted accordingly. The steps of such a method, executed at a Presentity client will now be described in another block diagram of FIG. 5.

In a first step 500, the Presentity client receives a request, e.g. a Winfo notification, comprising user specific information, typically delivered in some form of an XML document extension associated with the requesting Watcher. The Presentity client interprets attributes retrieved from the user specific information in another step 501, in order to retrieve the attributes in a user readable format. Once the interpreted attributes has been presented to the Presentity, e.g. via a conventional user interface, as indicated with a step 502, the request may either be responded to by the Presentity, authorizing or denying the request via the user interface in a subsequent step 503. In a final step 504 a response is generated and transmitted to the Presence System, which in turn will generate and transmit a corresponding response to the Watcher.

A Presence System, comprising at least one Presence Server, interacting with at least one Presence XDMS will be able to manage the authorization procedure described above if the Presence Server is adapted accordingly, while the associated Presence XDMS may remain unchanged.

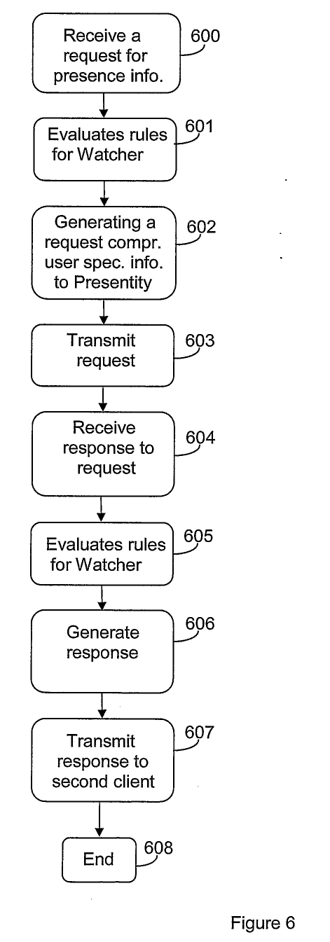

The steps for executing the authorization method in a Presence System, according to one embodiment, will now be described with reference to the block diagram of FIG. 6.

In a first step 600 of FIG. 6, the Presence Server of the Presence System receives a request, which may be e.g. a SIP subscribe, from a Watcher requesting for presence information associated with a specific Presentity. In response to this request, Presence Server evaluates the presence rules of the respective Watcher at a Presence XDMS, all according to well known procedures. Such a procedure is indicated with a next step 601.

In another step 602 a request for authorization, comprising an XML document extension, is generated and in a subsequent step 603, the request is transmitted to the Presentity. When a response has been received from the Presentity, comprising either an authorization of the one or more authorized attributes, or a denial, as indicated in a step 604, the presence rules of the Watcher is once again evaluated in another step 605. Also this evaluation is executed all according to known procedures, considering the authorized attributes and the predetermined evaluation rules. As a result from this evaluation, Presence Server generates a response in another step 606. The response is then transmitted to the Watcher, indicating the authorized attributes, in case the request has been authorized, or a denial of the request. This is done in a step 607, before the authorization procedure is terminated in a final step 608, terminating the authorization procedure.

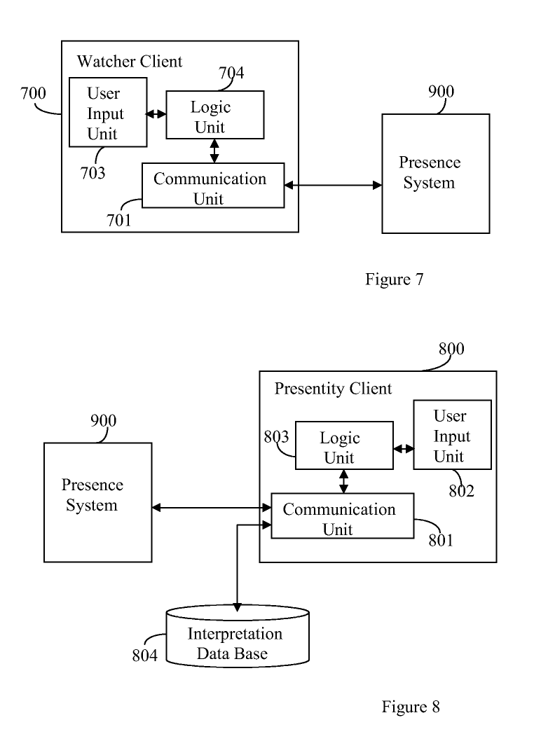

A Watcher Client, i.e. a generic function adapted to initiate and execute an authorization method according to any of the embodiments described above, will now be described with reference to FIG. 7.

A Watcher Client 700 according to one embodiment comprises a communication unit 701, adapted to communicate with a Presence System 900. The Watcher Client 700 also comprises a User Input Unit 703, through which a user may select attributes according to personal preferences, thereby defining a first set of watcher specific information. The User Input Unit 703, may be implemented, using any type of conventional User Input technique. In addition, the Watcher Client 700 also comprises a Logic Unit 704, which, according to one embodiment, may be adapted to generate a request, e.g. a SIP subscribe, comprising an XML document extension, such as e.g. a filter, according to the authorization mechanism described above.

A Presentity, which requires to authorize requests for presence information according to a method according to the one described in this document will have to be provided with a user equipment, comprising a Presentity Client specially adapted therefore. Such a Presentity client, according to one embodiment, will now be described with reference to FIG. 8.

In FIG. 8, a Presentity client 800 comprises a communication unit 801, which is adapted to receive messages associated with a presence service from a Presence System 900. Presentity Client 800 also comprises a conventional User Input Unit 802, adapted to present options received from Presence System 900 for the Presentity, and for receiving and registering the selected choice made by the Presentity.

A Logic Unit 803 is adapted to generate a response to an authorization request. In an alternative embodiment, the Logic Unit 803, may also be adapted to generate an automated authorization response, all according to pre-configured authorization rules. The logic unit 803 is also adapted to execute an interpretation procedure in response to receiving a request for authorization from the Presence System 900. The interpretation may be achieved by contacting an internal or an external database 804, adapted to store an interpretation table comprising the attributes used by the suggested presence service.

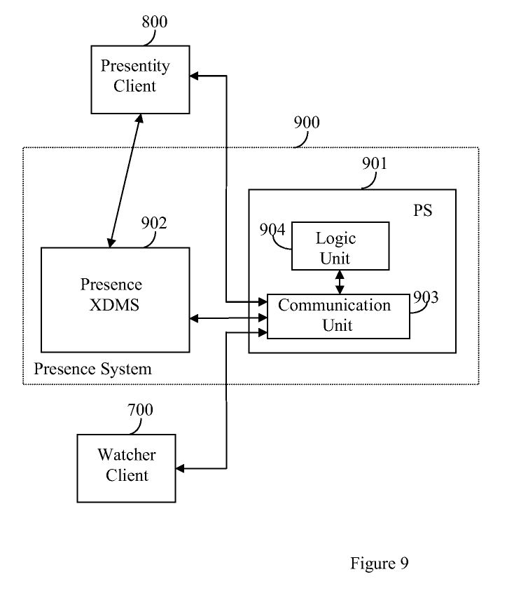

A Presence System 900, adapted to manage the authorization method described above according to one exemplified configured will now be described in further detail, referring to FIG. 9, wherein the Presence System 900 comprises an adapted Presence Server (Presence Server) 901 and a conventional Presence XDMS 902. Since the Presence XDMS 902 is a conventional Presence XDMS operating in a conventional way, the architecture of this entity will not be discussed in any further detail in this document.

Presence Server 901 comprises a Communication Unit 903, adapted to communicate with at least one Watcher Client 700 and at least one Presentity Client 800, participating in a procedure for exchanging presence information, as well as with Presence XDMS 902. Presence Server 901 also comprises a Logic Unit 904, adapted to manage the authorization procedure between Watcher Client 700 and Presentity Client 800, and to execute the respective checking procedures, involving interrogating the Presence XDMS 902 for pre-configured rules, which may have been defined for certain Watchers.

While the invention has been described with reference to specific exemplary embodiments, the description is in general only intended to illustrate the inventive concept and should not be taken as limiting the scope of the invention. Although concepts, such as e.g. SIP and IMS have been used when describing the above embodiments, any other similar suitable standards, protocols and network elements may basically be used as described herein. The present invention is generally defined by the following independent claims.

1. A method of responding to a request for presence information associated with a first client, said request being initiated by a second client, wherein said method comprises the following steps, executed by said first client:
receiving a request message, requesting for presence information of the first client from a presence system, said request comprising a set of client specific information associated with the second client, wherein said client specific information comprises at least one attribute,
interpreting said at least one attribute,
presenting the at least one interpreted attribute to the user of said first client,
generating a response message upon receiving a response to said presentation, wherein said response message authorizes said request according to the at least one attribute or a sub-set thereof, or denies said request, and
transmitting said response message to said presence system.

2. The method according to claim 1, wherein said request message is a SIP notify message.

3. The method according to claim 1, wherein said interpreting step comprises obtaining an interpretation of said one or more attributes from a pre-configured table.

4. The method according to claim 3, wherein said requesting step comprises transmitting a HTTP request to a WEB server, said WEB server having access to said pre-configured table.

5. The method according to claim 1, wherein said generating step comprises generating a HTTP/XCAP put message, comprising “Allow”, in case the request is authorized.

6. The method according to claim 1, wherein said generating step comprises generating a HTTP/XCAP PUT message, comprising “Block”, or “Polite block”, in case the request is denied.

7. A method of requesting for presence information associated with a first client, said method comprising the following steps, executed by a requesting second client:
generating a request message, requesting for presence information, wherein said request message comprises client specific information associated with said second client,
transmitting said request message to a presence system,
receiving a response message, responding to said request message, wherein said response message authorizes said request according to said at least one attribute or a sub-set thereof, or denies said request, said at least one attribute being associated with said client specific information and provided to said first client from the presence system.

8. The method according to claim 7, wherein said request message is a SIP subscribe message.

9. The method according to claim 7, wherein said response message is a SIP notify message.

10. The method according to claims 7, wherein said client specific information is an XML document extension, comprising at least one attribute.

11. The method according to claim 10, wherein said XML document extension is a filter.

12. The method according to claim 7, wherein said client specific information is transmitted to said presence server in the SIP header of the request message.

13. A method of handling a request for presence information associated with a first client, initiated by a second client, said method comprising the following steps, executed by a presence system:
receiving a first request message from said second client, said first request message requesting for presence information of said first client comprising a first set of client specific information associated with said second client,
generating a second request message comprising a second set of client specific information associated with said first set of client specific information, wherein said second set of client specific information comprises at least one attribute,
transmitting said second request message to the first client,
receiving a first response message from the first client message, wherein said first response message responding to the second request message authorizes the request according to all of the at least one attribute, or a sub-set thereof, or denies said request,
generating a second response message on the basis of the content of the first response message in response to receiving the first response message, and
transmitting said second response message to the second client.

14. The method according to claim 13, wherein the first request message is a SIP subscribe message.

15. The method according to claim 13, wherein the second request message and the second response message is a SIP notify message.

16. The method according to claim 13, wherein said first response message is a HTTP/XCAP put message.

17. The method according to claim 13, wherein the second set of client specific information is an XML document extension, comprising at least one attribute, associated with the second client.

18. The method according to claim 13, wherein prior to said generating step the following step is executed:
mapping content of said first set of client specific information to at least one attribute stored in a pre-configured filter, said at least one attribute forming said second set of client specific information.

19. A first client adapted to respond to a request for presence information associated with said first client, said request being initiated by a second client via a presence system, said first client comprising a communication unit, a user input unit and a logic unit, wherein said communication unit is adapted to receive a request message, requesting for presence information of the first client from the presence system, said request message comprising a set of client specific information associated with the second client, wherein said client specific information comprises at least one attribute, said logic unit being adapted to interpret the at least one attribute, wherein said logic unit is adapted to manage an interpretation of said at least one attribute, and wherein said user interface unit is adapted to present said at least one interpreted attribute to the user of said first client, said logic unit being further adapted to generate a response message upon receiving a response to said presentation from the user input unit, said response message authorizing the request according to said at least one attribute, or a sub-set thereof, or denying said request, and said communication unit being further adapted to transmit said response message to the presence system.

20. The first client according to claim 19, wherein said request message is a SIP notify message.

21. The first client according to claim 19 or 20, wherein said response message is a HTTP/XCAP put message.

22. The first client according to claim 19, wherein said logic unit is further adapted to execute said interpretation by interrogating a pre-configured table, comprising interpretations of said at least one attribute.

23. A second client adapted to request for presence information of a first client, said second client comprising a communication unit and a logic unit, wherein said logic unit is adapted to generate a request message requesting for presence information associated with said first client, said request message comprising client specific information associated with said second client, and wherein said communication unit is adapted to receive a response message, responding to the request message, said response message authorizing said request according to said at least one attribute or a sub-set thereof, or denying said request, said at least one attribute being associated with said client specific information and provided to said first client from the presence system.

24. The second client according to claim 23, said second client further comprising a user input unit, adapted to retrieve said set of client specific information in response to a user interaction executed by a user of said second client.

25. A presence server of a presence system for handling a request for presence information associated with a first client, said request being initiated by a second client, wherein said presence server comprise a communication unit and a logic unit, said communication unit being adapted to receive a first request message from said second client, said first request message, requesting for presence information associated with said first client, comprising a first set of client specific information associated with said second client, and wherein said logic unit is adapted to generate a second request message, comprising a second set of client specific information associated with said first set of client specific information, and wherein said second set of client specific information comprises at least one attribute, said communication unit being further adapted to receive a first response message from the first client subsequent to having transmitted said second request to the first client, said first response message, responding to the second request message, authorizing the request according to all of the at least one attribute or a sub-set thereof, or denying said request, and to transmit a second response message to the second client subsequent to having received the first response message, the logic unit being further adapted to generate said second response message, on the basis of the content of the first response message.

26. The presence server according to claim 25, wherein said first request message is a SIP subscribe message.

21. The presence server according to claim 25, wherein said second request message and said second response message is a SIP notify message.

28. The presence server according to claim 25, wherein said first response message is a HTTP/XCAP put message.

29. The presence server according to claim 25, wherein said logic unit is further adapted to map said first set of client specific information to at least one attribute stored in a pre-configured filter, forming said second set of client specific information.
